(19) United States
(12) Patent Application Publication
(10) Pub. No.: US 2026/0151963 A1
(43) Pub. Date: Jun. 4, 2026

(54) THREE-DIMENSIONAL MOLDING DEVICE

(71) Applicant: SEIKO EPSON CORPORATION, Tokyo (JP)

(72) Inventor: Eiji OKAMOTO, MATSUMOTO-SHI (JP)

(21) Appl. No.: 19/401,612

(22) Filed: Nov. 26, 2025

(30) Foreign Application Priority Data
Nov. 29, 2024 (JP) 2024-208279

(51) Int. Cl. B29C 64/336; B29C 64/106; B29C 64/209; B29C 64/314; B29K 101/12; B29K 105/06; B33Y 30/00

(52) U.S. Cl. CPC B29C 64/336; B29C 64/106; B29C 64/209; B29C 64/314; B33Y 30/00; B29K 2101/12; B29K 2105/06

(57) ABSTRACT

The three-dimensional molding device includes a plasticizing section; a fiber material supply section; a first communication path through which the molten material passes; at least one second communication path through which the fiber material passes; a flow path configured to allow path of the molten material that has passed through the first communication path and the fiber material that has passed through the second communication path; a material switching section that controls communication among the first communication path, the second communication path, and the flow path; a nozzle; and a control section; wherein the material switching section includes a rotating section that rotates about a rotation axis along an axial direction of the flow path, and the control section controls the material switching section to establish communication between the first communication path and the flow path, in order to switch among the following modes: a first mode in which the second communication path and the flow path do not communicate with each other; a second mode in which both the first communication path and the second communication path are in communication with the flow path; and a third mode in which neither the first communication path nor the second communication path communicates with the flow path.

The present application is based on, and claims priority from JP Application Serial Number 2024-208279, filed Nov. 29, 2024, the disclosure of which is hereby incorporated by reference herein in its entirety.

### BACKGROUND

### 1. Technical Field

The present disclosure relates to a three-dimensional molding device.

### 2. Related Art

The disclosure in JP-A-2022-131037 discloses a three-dimensional molding device that introduces a second fiber material, which is longer than the first fiber material, into a molten material containing the first fiber material and a thermoplastic resin, and forms a three-dimensional molded object containing both the first fiber material and second fiber material.

In the three-dimensional molding device, switching between ejection of the molten material and ejection of the fiber material from the nozzle has not been considered.

### SUMMARY

According to a first aspect of the present disclosure, a three-dimensional molding device is provided.

The three-dimensional molding device includes a plasticizing section configured to plasticize at least a portion of a material containing thermoplastic resin to generate molten material; a fiber material supply section configured to supply fiber material; a first communication path communicating with the plasticizing section and configured to allow the molten material to pass through; at least one second communication path communicating with the fiber material supply section and through which the fiber material passes; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage, wherein the material switching section includes a rotating section that rotates about a rotation axis that is along an axial direction of the flow path, and the control section controls the material switching section to switch between the following modes: a first mode in which the first communication path is in communication with the flow path and the second communication path is not in communication with the flow path, a second mode in which both the first communication path and the second communication path are in communication with the flow path, and a third mode in which neither the first communication path nor the second communication path communicates with the flow path.

### BRIEF DESCRIPTION OF THE DRAWINGS

FIG. 1 is an explanatory diagram illustrating a schematic configuration of a three-dimensional

molding device according to a first embodiment.

FIG. 2 is an explanatory view illustrating a schematic configuration of a plasticization material introduction section.

FIG. 3 is a perspective view showing a schematic configuration of a flat screw.

FIG. 4 is a schematic plan view of a barrel.

FIG. 5 is an explanatory view illustrating a schematic configuration of a fiber material introduction section, a material switching section, and an ejection section.

FIG. 6 is a top view of the rotating section.

FIG. 7 is a cross-sectional view taken along the section line VII-VII in FIG. 6.

FIG. 8 is a cross-sectional view taken along line VIII-VIII in FIG. 6.

FIG. 9 is a perspective view illustrating a positional relationship among a first communication path, a second communication path, and a rotating section.

FIG. 10 is a diagram illustrating a state of communication among the first communication path, the second communication path, and the flow path via the rotating section in the first mode.

FIG. 11 is a diagram illustrating a state of communication among the first communication path, the second communication path, and the flow path via the rotating section in the second mode.

FIG. 12 is a diagram illustrating a state of communication among the first communication path, the second communication path, and the flow path via the rotating section in the third mode.

### DESCRIPTION OF EMBODIMENTS

### A. First Embodiment

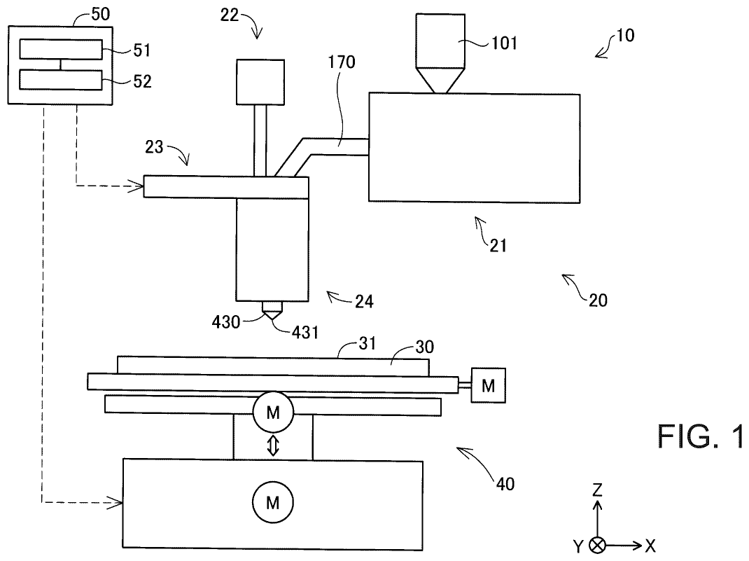

FIG. 1 is an explanatory view showing a schematic configuration of a three-dimensional molding device 10 in a first embodiment. In FIG. 1, arrows indicating X, Y, and Z directions orthogonal to each other are shown. The X direction and the Y direction are directions parallel to a horizontal plane. The Z direction is a direction parallel to the vertical direction. The X, Y, and Z directions in FIG. 1 and the X, Y, and Z directions in other drawings indicate the same directions. When a direction is specified, positive and negative signs are used together with the direction notation, wherein the positive direction, which is the direction indicated by the arrow, is “+,” and the negative direction, which is the direction opposite to the direction indicated by the arrow, is “−.” The +Z direction is also referred to as “up,” and the −Z direction is also referred to as “down.”

The three-dimensional molding device 10 is a device that molds a three-dimensional molded object by a material ejection method. The three-dimensional molding device 10 includes a molding section 20 that generates and ejects a molten material, a molding stage 30 serving as a base stage of a three-dimensional molded object, a movement mechanism 40 that controls an ejection position of the molten material, and a control section 50 that controls each section of the three-dimensional molding device 10.

The molding section 20 ejects a molten material obtained by plasticizing a material in a solid state onto the stage 30 under the control of the control section 50. The molding section 20 includes a molten material introduction section 21, a fiber material introduction section 22, a material switching section 23, and a ejection section 24.

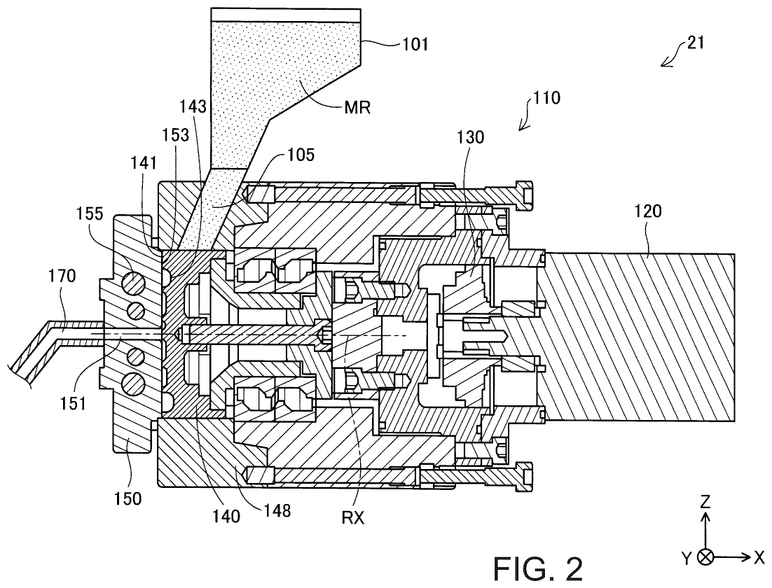

FIG. 2 is an explanatory view illustrating a schematic configuration of the molten material introduction section 21. The molten material introduction section 21 generates a molten material and guides the generated molten material to the material switching section 23. The molten material introduction section 21 includes a material supply section 101, a plasticizing section 110, and a first communication path 170.

The material supply section 101 supplies the material MR to the plasticizing section 110. The material supply section 101 is configured by, for example, a hopper that accommodates the material MR. The material supply section 101 is connected to the plasticizing section 110 via a material supply path 105. The material MR is put in the material supply section 101 in the form of pellets, powder, or the like. As the material MR, for example, thermoplastic resin such as acrylonitrile butadiene styrene (ABS), polyether ether ketone (PEEK), polypropylene (PP) or the like, is used. The material MR may include inorganic material such as metal or ceramic.

The plasticizing section 110 generates a pasty molten material in which fluidity is expressed by plasticizing at least a portion of the material MR supplied from the material supply section 101. In the present embodiment, “plasticization” means a concept including melting, and means a change from a solid state to a fluid state. Specifically, in the case of a material in which glass transition occurs, plasticization means that the temperature of the material is set to be equal to or higher than the glass transition point. In the case of a material in which glass transition does not occur, plasticization means that the temperature of the material is raised to or higher than the melting point. The plasticizing section 110 includes a drive motor 120, a decelerator 130, a flat screw 140, and a barrel 150. The flat screw 140 is also referred to as a rotor, a scroll, or simply a screw. The barrel 150 is also called a screw facing section.

The flat screw 140 is housed in a screw case 148. The flat screw 140 is connected to the drive motor 120 via the decelerator 130, and rotates about the rotation axis RX in the screw case 148 by a rotational driving force generated by the drive motor 120. In the present embodiment, the direction of the rotation axis RX is along the X direction.

The rotation of the flat screw 140 by the drive motor 120 is controlled by the control section 50. The barrel 150 is arranged on the −X direction side of the flat screw 140.

The flat screw 140 may be directly coupled to the drive motor 120 without the decelerator 130.

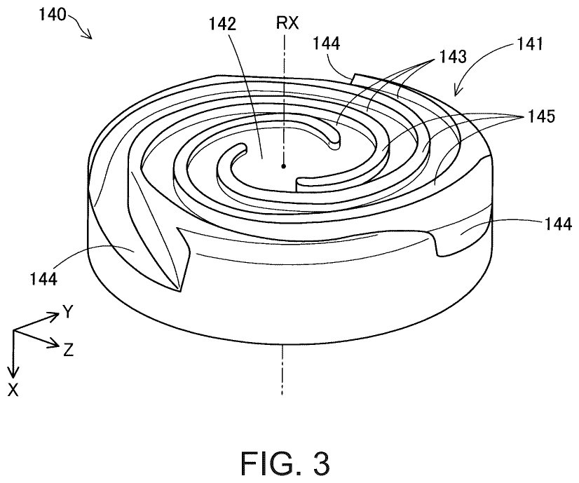

FIG. 3 is a perspective view showing a schematic configuration of the flat screw 140. The flat screw 140 has a substantially columnar shape in which the height in the direction along the central axis is smaller than the diameter. The central axis of the flat screw 140 coincides with the rotation axis RX. A spiral groove 143 is formed around a central section 142 on a groove forming surface 141 of the flat screw 140 facing the barrel 150. The groove 143 communicates with a material introduction port 144 formed on a side surface of the flat screw 140. The material MR supplied from the material supply section 101 is supplied to the groove 143 through the material introduction port 144. The grooves 143 are formed by being separated from each other by ridge sections 145. FIG. 3 shows an example in which three grooves 143 are formed, but the number of grooves 143 may be one, two, or more. The grooves 143 are not limited to a spiral shape, may be helical or involute curvilinear, and may extend so as to draw an arc from the central section 142 to the outer periphery.

As illustrated in FIG. 2, a barrel heater 155 for heating the material MR supplied into the groove 143 of the flat screw 140 is embedded in the barrel 150. The temperature of the barrel heater 155 is controlled by the control section 50.

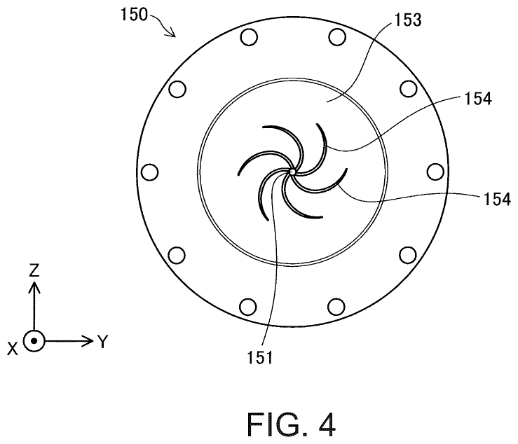

FIG. 4 is a schematic plan view of the barrel 150. The barrel 150 has a facing surface 153 that faces the groove forming surface 141 of the flat screw 140. A communication hole 151 penetrating the barrel 150 in the X direction is formed at the center of the facing surface 153. A plurality of guide grooves 154 connected to the communication hole 151 and extending in a spiral shape from the communication hole 151 toward the outer periphery are formed in the facing surface 153. The barrel 150 may not be provided with the guide groove 154.

The guide groove 154 may not be connected to the communication hole 151.

The material MR supplied to the groove 143 of the flat screw 140 flows along the groove 143 and the guide groove 154 by the rotation of the flat screw 140 while being plasticized between the flat screw 140 and the barrel 150 by the rotation of the flat screw 140 and the heating of the barrel heater 155, and is guided to the central section 142 of the flat screw 140. The molten material flowing into the central section 142 flows out from the communication hole 151 provided at the center of the barrel 150 to the first communication path 170. Note that in the molten material, all the substances constituting the molten material may not be plasticized. It is sufficient that the molten material is converted into a state having fluidity as a whole by plasticizing at least some kinds of substances among substances constituting the molten material.

The first communication path 170 communicates between the plasticizing section 110 and the material switching section 23. One end of the first communication path 170 is connected to the communication hole 151, and the other end of the first communication path 170 is connected to the material switching section 23. In other words, the first communication path 170 communicates with the plasticizing section 110. The molten material generated in the plasticizing section 110 passes through the first communication path 170 and flows out to the material switching section 23.

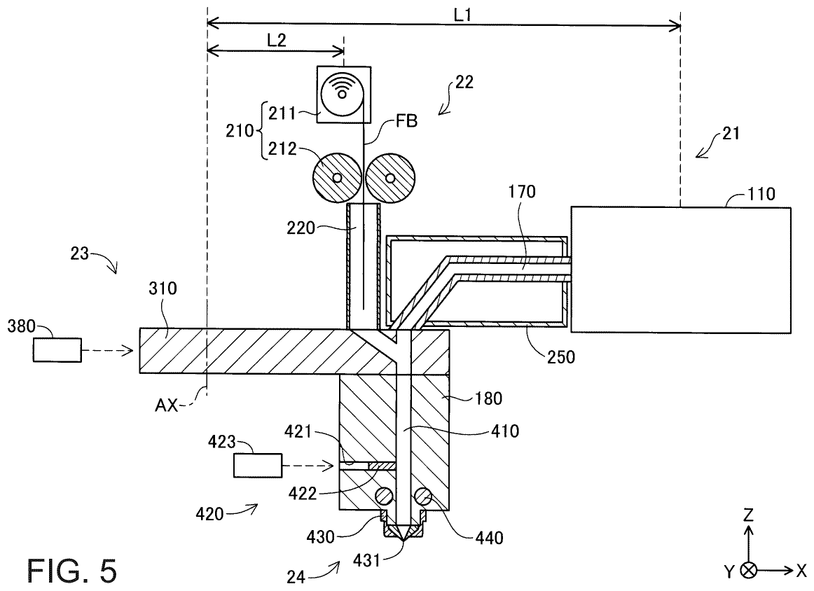

FIG. 5 is an explanatory diagram illustrating a schematic configuration of the fiber material introduction section 22, the material switching section 23, and the ejection section 24. Although not shown in FIG. 5, in the present embodiment, the molding section 20 includes three fiber material introduction sections 22. Hereinafter, a configuration of one fiber material introduction section 22 will be described with reference to FIG. 5. The fiber material introduction section 22 includes a fiber material supply section 210 and a second communication path 220.

The fiber material supply section 210 supplies the fiber material FB to the material switching section 23. The fiber material supply section 210 includes an accommodation section 211 and a transport roller 212. The fiber material FB wound around a reel is accommodated in the accommodation section 211. The transport rollers 212 are a pair of rollers that sandwich the fiber material FB supplied from the accommodation section 211. The transport roller 212 is provided below the accommodation section 211. The transport rollers 212 rotate about the each axes thereof in a state of sandwiching the fiber material FB, and thus the fiber material FB is transported from the accommodation section 211 toward the material switching section 23. In the present embodiment, the direction along the axis of the transport roller 212 is the Y direction. The rotation of the transport roller 212 is controlled by the control section 50. The method of transporting the fiber material FB is not limited to the above-described method. For example, the fiber material FB may be transported from the accommodation section 211 toward the material switching section 23 by rotating a reel around which the fiber material FB is wound by a motor.

The second communication path 220 is a cylindrical member provided below the transport roller 212, and the fiber material FB sent out from the accommodation section 211 passes through the inside thereof. The second communication path 220 communicates with the fiber material supply section 210. In the present embodiment, the axis of the second communication path 220 is along the Z direction. The lower end of the second communication path 220 is connected to the material switching section 23.

The fiber material FB supplied from the fiber material supply section 210 passes through the second communication path 220 and is transported to the material switching section 23.

The fiber material FB is formed of a fiber bundle in which a plurality of fibers is bundled. In the present embodiment, the fiber material FB has a configuration in which a plurality of carbon fibers are bundled by a bundling agent. The fiber material FB may be made of fiber material other than carbon fiber, and may be made of, for example, glass fiber. The fiber material FB may be formed of various fibers having a higher elastic modulus than the material MR. The fiber material FB may be formed of one fiber. The fiber material FB may be a fiber bundle in which a plurality of fibers is bundled or a material in which a single fiber is impregnated with a thermoplastic resin. The diameter of the fiber material FB may be, for example, 5 μm or more and equal to or less than the hole diameter of a nozzle opening 431 described later. Here, the diameter of the fiber material FB corresponds to the maximum width dimension in a cross section orthogonal to the length direction of the fiber bundle constituting the fiber material FB.

A heat insulation material 250 is provided between the second communication path 220 and the plasticizing section 110. In the present embodiment, the heat insulation material 250 is a box-shaped member that accommodates the first communication path 170. The heat insulation material 250 is made of, for example, ceramic, glass fiber, polytetrafluoroethylene (PTFE), or the like. The heat insulation material 250 may be provided between the second communication path 220 and the plasticizing section 110, and may be, for example, a box-shaped member that accommodates the entire plasticizing section 110.

The material switching section 23 is connected to the first communication path 170, the second communication path 220, and a flow path 410 described later, and switches communication between the first communication path 170, the second communication path 220, and the flow path 410. The material switching section 23 includes a rotating section 310 that rotates about a rotation axis AX along the axial direction of the flow path 410. The direction along the rotation axis AX is the Z direction. The rotating section 310 is driven by a first drive section 380 under the control of the control section 50. The first drive section 380 is constituted by, for example, a stepping motor. The control section 50 controls the rotation angle of the rotating section 310 about the rotation axis AX using the first drive section 380. When viewed from the direction along the rotation axis AX, a distance L1 between the rotation axis AX and the plasticizing section 110 is longer than a distance L2 between the rotation axis AX and the fiber material supply section 210. The detailed structure of the rotating section 310 will be described later.

The ejection section 24 includes the flow path 410, a suction section 420, a nozzle 430, and a nozzle heater 440. The flow path 410 is a hole extending linearly and formed in a block 180, which is a member disposed on the −Z direction side of the rotating section 310. The axis of the flow path 410 extends along the Z direction. The flow path 410 is connected to the material switching section 23, and the molten material passing through the first communication path 170 and the fiber material FB passing through the second communication path 220 can pass through the flow path 410.

The nozzle 430 is arranged at the lower end of the block 180. The nozzle 430 communicates with the flow path 410 and ejects the molten material and the fiber material FB passing through the flow path 410 from the nozzle opening 431 at the distal end toward the stage 30.

The nozzle heater 440 is arranged around a portion of the flow path 410 located in the vicinity of the nozzle 430. The nozzle heater 440 heats the molten material in the flow path 410 in the vicinity of the nozzle 430. The temperature of the nozzle heater 440 is controlled by the control section 50.

The suction section 420 suppresses the tailing phenomenon, in which the molten material drips like a thread from the nozzle opening 431, by temporarily suctioning the molten material in the flow path 410 when the molten material ejecting from the nozzle 430 is paused. The suction section 420 includes a branch path 421, a plunger 422, and a plunger drive section 423. The branch path 421 is a hole formed in the block 180 and extending linearly, and is connected to the flow path 410. In the present embodiment, the direction in which the branch path 421 extends is the X direction. The plunger 422 is a shaft-shaped member and is arranged in the branch path 421. The plunger drive section 423 generates a driving force for instantaneously reciprocating the plunger 422 in the branch path 421 under the control of the control section 50. The plunger drive section 423 is configured by, for example, an actuator such as a solenoid mechanism, a piezoelectric element, or a motor. When temporarily interrupting the ejection of molten material from the nozzle 430, the control section 50 controls the plunger drive section 423 to instantaneously move the plunger 422 so that its distal end section shifts from the connecting section between the flow path 410 and the branch path 421 to a sequestered place within the branch path 421. Accordingly, a portion of the molten material in the flow path 410 is sucked into the branch path 421, and a negative pressure is generated in the flow path 410. When the fiber material FB is not present in the flow path 410 and only the molten material is present, the control section 50 moves the plunger 422 to suck the molten material in the flow path 410. The ejection section 24 may not include the suction section 420.

As shown in FIG. 1, the stage 30 is arranged at a position facing the nozzle opening 431 of the nozzle 430. The shaping surface 31 of the stage 30 facing the nozzle opening 431 is arranged so as to be parallel to the X and Y directions, that is, the horizontal direction. The stage 30 may be provided with a stage heater for suppressing rapid cooling of the molten material ejected onto the stage 30.

The movement mechanism 40 changes the relative position between the stage 30 and the nozzle 430 under the control of the control section 50. In the present embodiment, the position of the nozzle 430 is fixed, and the movement mechanism 40 moves the stage 30. The movement mechanism 40 is configured by a three axis positioner that moves the stage 30 in three axial directions of the X, Y, and Z directions by driving forces of three servo motors. In the present specification, unless otherwise specified, movement of the nozzle 430 means that the nozzle 430 or the ejection section 24 is relatively moved with respect to the stage 30.

Note that in another embodiment, instead of the configuration in which the stage 30 is moved by the movement mechanism 40, a configuration may be adopted in which the position of the stage 30 is fixed and the movement mechanism 40 moves the nozzle 430 with respect to the stage 30. A configuration in which the movement mechanism 40 moves the stage 30 in the Z direction and the nozzle 430 in the X and Y directions, or a configuration in which the movement mechanism 40 moves the stage 30 in the X and Y directions and the nozzle 430 in the Z direction, may be adopted. Even using these configurations, the relative positional relationship between the nozzle 430 and the stage 30 can be changed.

The control section 50 is a control device that controls operation of the entire three-dimensional molding device 10. The control section 50 is configured by a computer including a CPU 51, a storage device 52, and an input/output interface that inputs and outputs signals to and from the outside. The control section 50 functions to execute a molding process for molding a three-dimensional molded object by the CPU 51 executing a program or a command read on the main storage device. In the molding process, the control section 50 controls the plasticizing section 110, the fiber material supply section 210, the material switching section 23, the ejection section 24, and the movement mechanism 40 according to the molding data for molding the three-dimensional molded object, and molds the three-dimensional molded object including the molten material on the stage 30. In another embodiment, the control section 50 may be realized by a combination of a plurality of circuits for realizing at least a part of each function, instead of being constituted by a computer.

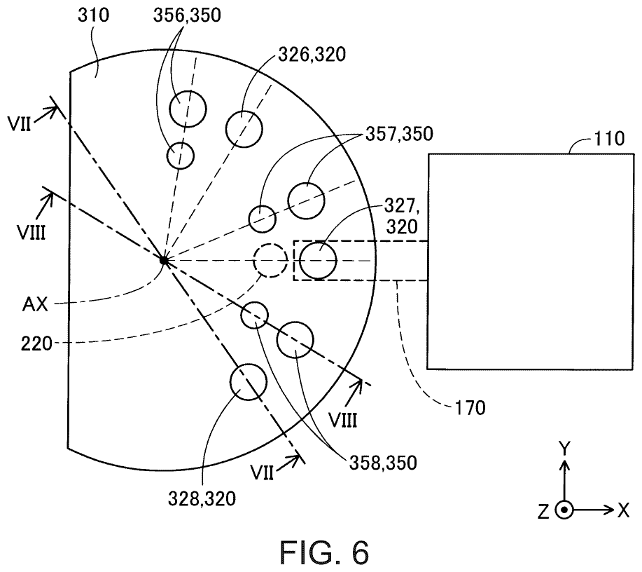

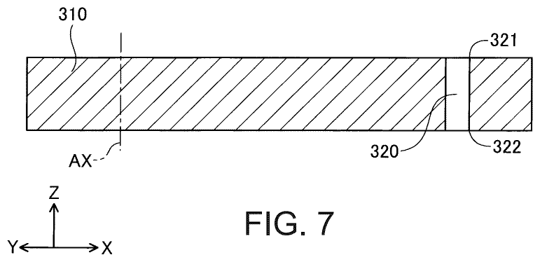

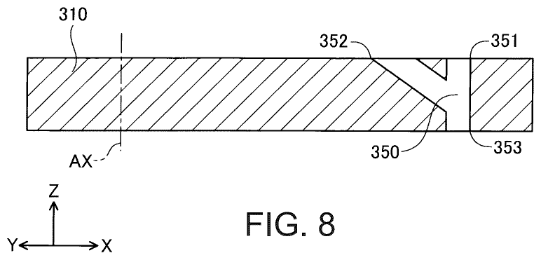

FIG. 6 is a top view of the rotating section 310. FIG. 7 is a cross-sectional view taken along the section line VII-VII in FIG. 6. FIG. 8 is a cross-sectional view taken along line VIII-VIII in FIG. 6. The rotating section 310 is a disk-shaped member with a portion cut off. In the present embodiment, the rotating section 310 includes three first paths 320 and three second paths 350, which are through holes penetrating the rotating section 310 in the Z direction. The rotating section 310 may be a plate-shaped member, and the shape thereof in plan view may be a circular shape, a polygonal shape, or the like.

The first path 320 is a through hole that allows the first communication path 170 and the flow path 410 to communicate with each other. As shown in FIG. 7, the first path 320 has a first opening 321 connectable to the first communication path 170 and a second opening 322 connectable to the flow path 410. The first opening 321 is an opening located at an end section of the first path 320 on the +Z direction side, and the second opening 322 is an opening located at an end section of the first path 320 on the −Z direction side. The axial direction of the first path 320 is a direction along the axial direction of the flow path 410. In the present embodiment, the axial direction of the first path 320 is a direction along the Z direction.

The second path 350 is a through hole that allows the first communication path 170 and the flow path 410 to communicate with each other and allows the second communication path 220 and the flow path 410 to communicate with each other. As illustrated in FIG. 8, the second path 350 includes a third opening 351 that is connectable to the first communication path 170, a fourth opening 352 that is connected to the second communication path 220, and a fifth opening 353 that is connectable to the flow path 410. The third opening 351 and the fourth opening 352 are openings located at the end section of the second path 350 on the +Z direction side, and the fifth opening 353 is an opening located at the end section of the second path 350 on the −Z direction side. The total opening area of the third opening 351 and the fourth opening 352 is larger than the opening area of the fifth opening 353. The fourth opening 352 and the third opening 351 are arranged side by side in the radial direction. Here, the radial direction is a direction orthogonal to the rotation axis AX and a direction away from the rotation axis AX. The fourth opening 352 and the third opening 351 are provided in this order along the radial direction.

The rotating section 310 includes a first plasticization material path 326, a second plasticization material path 327, and a third plasticization material path 328, which are the first paths 320. The first plasticization material path 326, the second plasticization material path 327, and the third plasticization material path 328 are provided at positions at which distances from the rotation axis AX are same. Specifically, the first opening 321 and the second opening 322 of each first path 320 are provided at positions equidistant from the rotation axis AX.

The rotating section 310 includes a first fiber material communication path 356, a second fiber material communication path 357, and a third fiber material communication path 358, which are the second paths 350. The first fiber material communication path 356, the second fiber material communication path 357, and the third fiber material communication path 358 are provided at positions equidistant from the rotation axis AX. Specifically, the third opening 351 of each second path 350, the fourth opening 352 of each second path 350, and the fifth opening 353 of each second path 350 are provided at positions equidistant from the rotation axis AX, respectively.

The distance between the first opening 321 of each first path 320 and the rotation axis AX is equal to the distance between the third opening 351 of each second path 350 and the rotation axis AX. The distance between the second opening 322 of each first path 320 and the rotation axis AX is equal to the distance between the fifth opening 353 of each second path 350 and the rotation axis AX. The first fiber material communication path 356, the first plasticization material path 326, the second fiber material communication path 357, the second plasticization material path 327, the third fiber material communication path 358, and the third plasticization material path 328 are provided in this order clockwise around the rotation axis AX when viewed from the +Z direction side. In other words, the first plasticization material path 326 and the second plasticization material path 327, which are the first paths 320, are provided between the two second paths 350 in the rotation direction of the rotating section 310. In the present embodiment, the rotation direction of the rotating section 310 is a clockwise direction about the rotation axis AX when viewed from the +Z direction side.

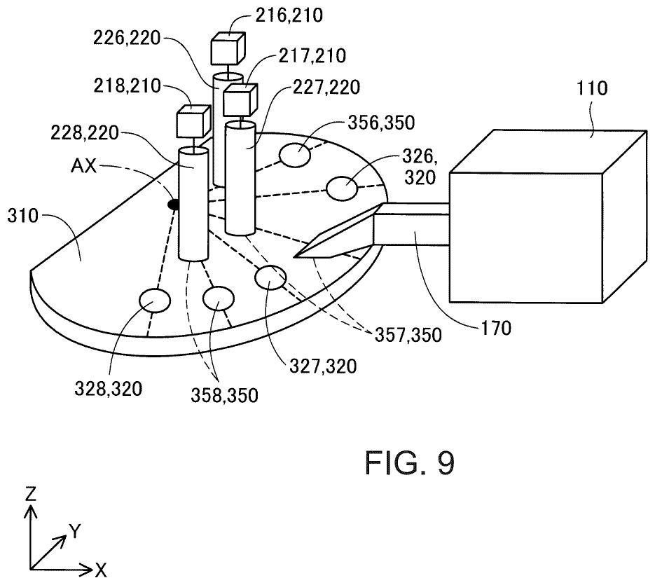

FIG. 9 is a perspective view illustrating a positional relationship between the first communication path 170, the second communication path 220, and the rotating section 310. As described above, the molding section 20 includes three fiber material introduction sections 22. The molding section 20 includes a first fiber material supply section 216, a second fiber material supply section 217, and a third fiber material supply section 218, which are fiber material supply sections 210. The molding section 20 includes a first fiber material communication path 226, a second fiber material communication path 227, and a third fiber material communication path 228, which are the second communication paths 220.

The first fiber material supply section 216 supplies the first fiber material to the first fiber material communication path 226. The second fiber material supply section 217 supplies the second fiber material to the second fiber material communication path 227. The third fiber material supply section 218 supplies the third fiber material to the third fiber material communication path 228. Here, the first fiber material, the second fiber material, and the third fiber material are different types of fiber materials FB. The first fiber material is, for example, carbon fiber, the second fiber material is, for example, glass fiber, and the third fiber material is, for example, aramid fiber.

Hereinafter, the end section of the second communication path 220 connected to the material switching section 23 is referred to as a second communication path opening 221. The second communication path opening 221 of each second communication path 220 is connected to the fourth opening 352 of a different second path 350. The second communication path opening 221 of the first fiber material communication path 226 is connected to the fourth opening 352 of the first fiber material communication path 356. The second communication path opening 221 of the second fiber material communication path 227 is connected to the fourth opening 352 of the second fiber material communication path 357. The second communication path opening 221 of the third fiber material communication path 228 is connected to the fourth opening 352 of the third fiber material communication path 358. The fiber material supply section 210 and the second communication path 220 rotate integrally with the rotating section 310 when the rotating section 310 rotates about the rotation axis AX. The molten material introduction section 21 and the ejection section 24 are fixed in the molding section 20.

In other words, each of the fiber material supply section 210, each of the second communication paths 220, and the rotating section 310 move relative to the molten material introduction section 21 and the ejection section 24.

The first communication path 170 is provided at a position where the distance between an first communication path opening 171 and the rotation axis AX is equal to the distance between the first opening 321 of each first path 320 and the rotation axis AX. Here, the first communication path opening 171 is an end section of the first communication path 170 connected to the material switching section 23. Accordingly, the rotating section 310 rotates about the rotation axis AX, and thus the first communication path opening 171 and the first opening 321 of each first paths 320 communicate with each other. The first communication path 170 is provided at a position where the distance between the first communication path opening 171 and the rotation axis AX is equal to the distance between the third opening 351 of each second paths 350 and the rotation axis AX. Accordingly, the rotating section 310 rotates about the rotation axis AX, and thus the first communication path opening 171 and the third opening 351 that is included in each second paths 350 are made to communicate with each other.

The control section 50 controls the material switching section 23 to switch between the first mode, the second mode, and the third mode. Specifically, the control section 50 rotates the rotating section 310 about the rotation axis AX to switch between the first mode, the second mode, and the third mode. Here, the first mode is a mode in which the first communication path 170 and the flow path 410 communicate with each other and the second communication path 220 and the flow path 410 do not communicate with each other. The second mode is a mode in which the first communication path 170 and the second communication path 220 communicate with the flow path 410. The third mode is a mode in which neither the first communication path 170 nor the second communication path 220 communicates with the flow path 410.

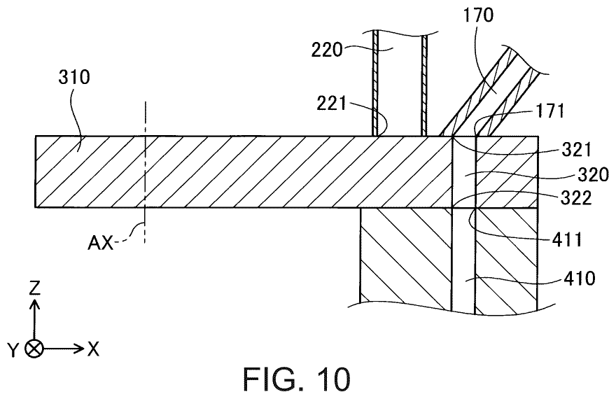

FIGS. 10 to 12 illustrate the communication state of the first communication path 170, the second communication path 220, and the flow path 410 via the rotating section 310 in each of the above-described modes. Hereinafter, the end section of the flow path 410 connected to the material switching section 23 is referred to as a flow path opening 411.

FIG. 10 illustrates a state of communication between the first communication path 170, the second communication path 220, and the flow path 410 via the rotating section 310 in the first mode. In the first mode, the control section 50 rotates the rotating section 310 about the rotation axis AX to a position where at least a portion of the first communication path opening 171 overlaps at least a portion of the first opening 321, and where at least a portion of the flow path opening 411 overlaps at least a portion of the second opening 322, and the flow path opening 411 does not overlap the fifth opening 353. Therefore, in the first mode, the molten material in the first communication path 170 passes through the first path 320 and flows out to the flow path 410, but the fiber material FB in the second communication path 220 is not transported to the flow path 410. Therefore, in the first mode, only the molten material is ejected from the nozzle 430. The ejection amount of the molten material from the nozzle 430 is controlled by adjusting the amount of the molten material generated by the plasticizing section 110, for example, by the control section 50 controlling the rotation speed of the flat screw 140. In the first mode, the first path 320 communicating with the first communication path 170 and the flow path 410 may be any of the first plasticization material path 326, the second plasticization material path 327, and the third plasticization material path 328.

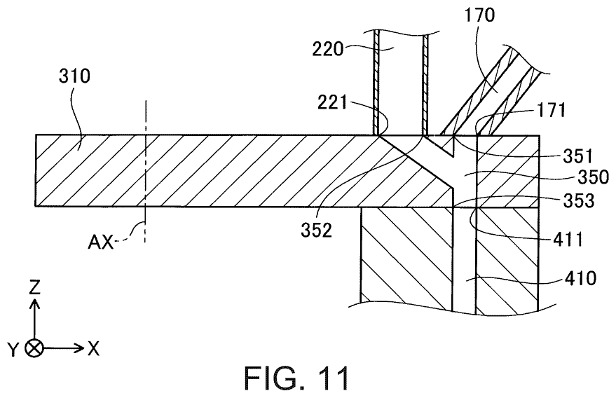

FIG. 11 illustrates a state of communication among the first communication path 170, the second communication path 220, and the flow path 410 via the rotating section 310 in the second mode. In the second mode, the control section 50 rotates the rotating section 310 about the rotation axis AX to a position where at least a portion of the first communication path opening 171 and at least a portion of the third opening 351 overlap each other and where at least a portion of the flow path opening 411 and at least a portion of the fifth opening 353 overlap each other. Therefore, in the second mode, the molten material in the first communication path 170 passes through the second path 350 and flows out to the flow path 410, and the fiber material FB in the second communication path 220 is transported to the flow path 410 via the second path 350.

Therefore, in the second mode, the molten material and the fiber material FB are ejected from the nozzle 430 The second path 350 that communicates with the first communication path 170, the second communication path 220, and the flow path 410 in the second mode is determined according to the type of the fiber material FB ejected from the nozzle 430. For example, when the first fiber material is ejected from the nozzle 430, the control section 50 rotates the rotating section 310 about the rotation axis AX to a position where the first fiber material communication path 356 communicates with the first communication path 170, the second communication path 220, and the flow path 410.

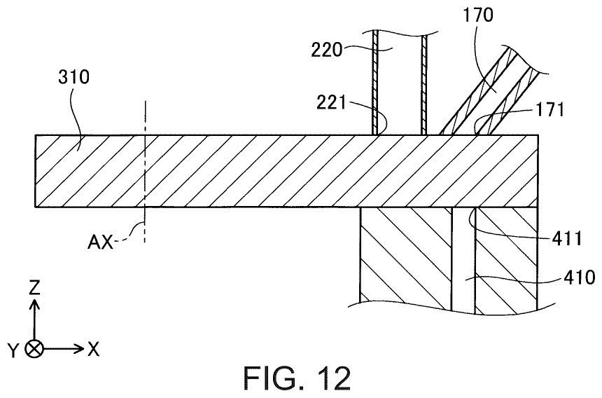

FIG. 12 illustrates a state of communication between the first communication path 170, the second communication path 220, and the flow path 410 via the rotating section 310 in the third mode. In the third mode, the control section 50 rotates the rotating section 310 about the rotation axis AX to a position where the flow path opening 411 does not overlap with any of the second opening 322 and the fifth opening 353. Therefore, in the third mode, the molten material in the first communication path 170 does not flow out to the flow path 410, and the fiber material FB in the second communication path 220 is not transported to the flow path 410. Therefore, in the third mode, neither the molten material nor the fiber material FB is ejected from the nozzle 430.

The control section 50 switches between the respective modes according to the molding data for molding the three-dimensional molded object. The control section 50 switches between the modes so that the fiber material FB is ejected to a portion of the three-dimensional molded object where the strength is to be improved, for example. The section of the three-dimensional molded object where the strength is desired to be improved is, for example, the outer enclosure of the three-dimensional molded object.

The control section 50 rotates the rotating section 310 around the rotation axis AX when switching the type of the fiber material FB ejected from the nozzle 430. For example, when the fiber material FB ejected from the nozzle 430 is switched from the first fiber material to the second fiber material, the control section 50 rotates the rotating section 310 about the rotation axis AX so that the state changes from the first state to the second state.

Here, the first state is a state in which at least a portion of the fifth opening 353 of the first fiber material communication path 356 and at least a portion of the flow path opening 411 overlap each other. The second state is a state in which at least a portion of the fifth opening 353 of the second fiber material communication path 357 and at least a portion of the flow path opening 411 overlap each other.

When the fiber material FB is cut, the control section 50 rotates the rotating section 310 about the rotation axis AX from a position where at least a portion of the flow path opening 411 and at least a portion of the second opening 322 overlap each other, to a position where the flow path opening 411 and the second opening 322 do not overlap each other. Alternatively, when the fiber material FB is cut, the control section 50 rotates the rotating section 310 about the rotation axis AX from a position where at least a portion of the flow path opening 411 and at least a portion of the fifth opening 353 overlap each other, to a position where the flow path opening 411 and the fifth opening 353 do not overlap each other. Accordingly, the fiber material FB is bent in the vicinity of the flow path opening 411, and thus the fiber material FB is cut.

The case of cutting the fiber material FB is a case of changing from a state in which the fiber material FB is ejected from the nozzle 430 to a state in which the fiber material FB is not ejected from the nozzle 430. For example, the case of switching from the second mode to the first mode or the third mode corresponds to the case of cutting the fiber material FB.

According to the first embodiment described above, the control section 50 controls the material switching section 23 to switch among the following three modes: a first mode in which the first communication path 170 communicating with the plasticizing section 110 and the flow path 410 communicating with the nozzle 430 communicate with each other, and the second communication path 220 communicating with the fiber material supply section 210 and the flow path 410 do not communicate with each other, a second mode in which the first communication path 170 and the second communication path 220 communicate with the flow path 410, and a third mode in which neither the first communication path 170 nor the second communication path 220 communicates with the flow path 410. Therefore, it is possible to switch between the ejection of the molten material from the nozzle 430 and the ejection of the fiber material FB.

In the present embodiment, the rotating section 310 includes the first path 320 which is a through hole capable of communicating the first communication path 170 and the flow path 410, and the second path 350 which is a through hole capable of communicating the first communication path 170 and the flow path 410, and the second communication path 220 and the flow path 410. The first path 320 includes the first opening 321 that is connectable to the first communication path 170 and the second opening 322 that is connectable to the flow path 410, the second path 350 has the third opening 351 that is connectable to the first communication path 170, the fourth opening 352 that is connected to the second communication path 220, and the fifth opening 353 that is connectable to the flow path 410, the axial direction of the first path 320 is a direction along the axial direction of the flow path 410, and the total opening area of the third opening 351 and the fourth opening 352 is larger than the opening area of the fifth opening 353. Therefore, by rotating the rotating section 310 about the rotation axis AX, it is possible to easily switch between the ejection of the molten material and the ejection of the fiber material FB from the nozzle 430.

In the present embodiment, in the first mode, the control section 50 rotates the rotating section 310 about the rotation axis AX to a position where at least a portion of the first communication path opening 171, which is the end section of the first communication path 170 connected to the rotating section 310, and at least a portion of the first opening 321 overlap each other, where at least a portion of the flow path opening 411, which is the end section of the flow path 410 connected to the rotating section 310, and at least a portion of the second opening 322 overlap each other, and to a position where the flow path opening 411 and the fifth opening 353 do not overlap each other. Therefore, in the first mode, only the molten material can be ejected from the nozzle 430.

In the present embodiment, in the second mode, the control section 50 rotates the rotating section 310 about the rotation axis AX to a position where at least a portion of the first communication path opening 171, which is the end section of the first communication path 170 connected to the rotating section 310, overlaps at least a portion of the third opening 351, and where at least a portion of the flow path opening 411, which is the end section of the flow path 410 connected to the rotating section 310, overlaps at least a portion of the fifth opening 353. Therefore, in the second mode, both the molten material and the fiber material FB can be ejected from the nozzle 430.

In the present embodiment, in the third mode, the control section 50 rotates the rotating section 310 about the rotation axis AX to a position where the flow path opening 411, which is the end section of the flow path 410 connected to the rotating section 310, does not overlap with any of the second opening 322 and the fifth opening 353. Therefore, in the third mode, it is possible to prevent neither the molten material nor the fiber material FB from being ejected from the nozzle 430.

In the present embodiment, the three-dimensional molding device 10 includes a plurality of second communication paths 220, and the fiber material supply section 210 supplies different types of fiber materials FB to the respective second communication paths 220. The rotating section 310 includes a plurality of second path 350, and the fourth opening 352 of each second path 350 is connected to the different second communication path 220. Therefore, different types of fiber materials FB may be ejected from the nozzle 430.

In the present embodiment, when the fiber material FB ejected from the nozzle 430 is switched from the first fiber material to the second fiber material, the control section 50 rotates the rotating section 310 about the rotation axis AX so that the state changes from the first state in which at least a portion of the fifth opening 353 of the first fiber material communication path 356 overlaps at least a portion of the flow path opening 411 which is the end section of the flow path 410 connected to the rotating section 310, to the second state in which at least a portion of the fifth opening 353 of the second fiber material communication path 357 overlaps at least a portion of the flow path opening 411. Therefore, the type of the fiber material FB ejected from the nozzle 430 can be easily switched.

In the present embodiment, the first path 320 is provided between the two second paths 350 in the rotation direction of the rotating section 310. Therefore, the second mode can be quickly switched to the first mode.

In the present embodiment, the fourth opening 352 and the third opening 351 are arranged side by side in a direction perpendicular to the rotation axis AX and away from it. Therefore, when the rotating section 310 includes a plurality of second paths 350, the third opening 351 and the fourth opening 352 communicating with each other can be easily recognized.

In the present embodiment, the heat insulation material 250 is provided between the second communication path 220 and the plasticizing section 110. Therefore, it is possible to reduce the influence of the heat of the plasticizing section 110 on the fiber material FB passing through the second communication path 220.

In addition, in the present embodiment, the nozzle heater 440 is arranged around a portion of the flow path 410 located in the vicinity of the nozzle 430. Therefore, since the molten material can be heated immediately before being ejected from the nozzle 430, the molten material can be more stably ejected from the nozzle 430.

### B. Other Embodiments

(B-1) In the above embodiment, the molding section 20 includes three fiber material introduction sections 22. In contrast, the molding section 20 may include one, two, or four or more fiber material introduction sections 22. That is, the molding section 20 may include one, two, or four or more second communication paths 220. In the above embodiment, the rotating section 310 includes three second paths 350.

In contrast, the rotating section 310 may include one, two, or four or more second paths 350. Each of the second communication path 220 is connected to a second path 350.

(B-2) In the above embodiment, the rotating section 310 includes three first paths 320. In contrast, the rotating section 310 may include one, two, or four or more first paths 320.

(B-3) In the above embodiment, the axial direction of the first path 320 is a direction along the axial direction of the flow path 410. In contrast, the axial direction of the first path 320 may not be a direction along the axial direction of the flow path 410.

(B-4) In the above embodiment, the total opening area of the third opening 351 and the fourth opening 352 is larger than the opening area of the fifth opening 353. In contrast, the total opening area of the third opening 351 and the fourth opening 352 may not be larger than the opening area of the fifth opening 353.

(B-5) In the above embodiment, in the first mode, the control section 50 rotates the rotating section 310 about the rotation axis AX to a position where at least a portion of the first communication path opening 171 overlaps at least a portion of the first opening 321, and where at least a portion of the flow path opening 411 and at least a portion of the second opening 322 overlap each other, and where the flow path opening 411 does not overlap the fifth opening 353. In contrast, in the first mode, the control section 50 may not rotate the rotating section 310 about the rotation axis AX to a position where at least a portion of the first communication path opening 171 overlaps at least a portion of the first opening 321, and where at least a portion of the flow path opening 411 and at least a portion of the second opening 322 overlap each other, and where the flow path opening 411 does not overlap the fifth opening 353.

(B-6) In the above embodiment, in the second mode, the control section 50 rotates the rotating section 310 about the rotation axis AX to a position where at least a portion of the first communication path opening 171 and at least a portion of the third opening 351 overlap each other and where at least a portion of the flow path opening 411 and at least a portion of the fifth opening 353 overlap each other. In contrast, in the second mode, the control section 50 may not rotate the rotating section 310 about the rotation axis AX to a position where at least a portion of the first communication path opening 171 and at least a portion of the third opening 351 overlap each other and where at least a portion of the flow path opening 411 and at least a portion of the fifth opening 353 overlap each other.

(B-7) In the above embodiment, in the third mode, the control section 50 rotates the rotating section 310 about the rotation axis AX to a position where the flow path opening 411 does not overlap with any of the second opening 322 and the fifth opening 353. In contrast, in the third mode, the control section 50 may not rotate the rotating section 310 about the rotation axis AX to a position where the flow path opening 411 does not overlap with any of the second opening 322 and the fifth opening 353.

(B-8) In the above embodiment, the first path 320 is provided between the two second paths 350 in the rotation direction of the rotating section 310. In contrast, the first path 320 may not be provided between the two second paths 350 in the rotation direction of the rotating section 310.

(B-9) In the above embodiment, the fourth opening 352 and the third opening 351 are arranged in the radial direction, which is perpendicular to the rotation axis AX and extends away from it side by side. In contrast, the fourth opening 352 and the third opening 351 may not be arranged side by side in the radial direction.

(B-10) In the above embodiment, the distance L1 between the rotation axis AX and the plasticizing section 110 is longer than the distance L2 between the rotation axis AX and the fiber material supply section 210 when viewed from the direction along the rotation axis AX. In contrast, the distance L1 between the rotation axis AX and the plasticizing section 110 may not be longer than the distance L2 between the rotation axis AX and the fiber material supply section 210 when viewed from the direction along the rotation axis AX.

(B-11) In the above embodiment, the heat insulation material 250 is arranged between the second communication path 220 and the plasticizing section 110. In contrast, the heat insulation material 250 may not be provided between the second communication path 220 and the plasticizing section 110.

(B-12) In the above embodiment, the ejection section 24 includes the nozzle heater 440. In contrast, the ejection section 24 may not include the nozzle heater 440.

(B-13) In the above embodiment, the ejection amount of the molten material from the nozzle 430 is controlled by, for example, the control section 50 controlling the rotation speed of the flat screw 140. On the other hand, by the control section 50 controlling the rotation angle of the rotating section 310 around the rotation axis AX, the ejection amount of the molten material from the nozzle 430 may be controlled by changing the area of the portion where the first communication path opening 171 and the first opening 321 overlap each other, or the area of the portion where the first communication path opening 171 and the third opening 351 overlap each other

### C. Other Forms

The present disclosure is not limited to the above-described embodiment, but can be realized in various forms without departing from the scope of the present disclosure. For example, the present disclosure can also be realized by the following forms. The technical features in the above-described embodiments that correspond to the technical features in each aspect described below can be replaced or combined as appropriate to solve some or all of the issues of this disclosure or to achieve some or all of the effects of this disclosure. Unless the technical features are described as essential in the present specification, the technical features can be appropriately deleted.

(1) According to a first embodiment of the present disclosure, the three-dimensional molding device is provided. three-dimensional molding device includes a plasticizing section configured to plasticize at least a portion of a material containing thermoplastic resin to generate molten material; a fiber material supply section configured to supply fiber material; a first communication path communicating with the plasticizing section and configured to allow the molten material to pass through; at least one second communication path communicating with the fiber material supply section and through which the fiber material passes; a flow path configured to allow passage of the molten material that passed through the first communication path and the fiber material that passed through the second communication path; a material switching section connected to the first communication path, to the second communication path, and to the flow path, and configured to switch communication state of the first communication path, the second communication path, and the flow path; a nozzle that communicates with the flow path and that ejects the molten material and the fiber material that passed through the flow path onto a stage; and a control section configured to control the plasticizing section, the fiber material supply section, and the material switching section to form a three-dimensional molded object including the molten material on the stage, wherein the material switching section includes a rotating section that rotates about a rotation axis that is along an axial direction of the flow path, and the control section controls the material switching section to switch among a first mode in which the first communication path is in communication with the flow path and the second communication path is not in communication with the flow path, a second mode in which both the first communication path and the second communication path are in communication with the flow path, and a third mode in which neither the first communication path nor the second communication path communicates with the flow path.

According to this configuration, it is possible to switch between the ejection of the molten material and the ejection of the fiber material from the nozzle.

(2) In the above-described aspect, may be such that the rotating section include a first path that is a through hole configured to communicate the first communication path with the flow path, and at least one second path that is a through hole configured to communicate the first communication path with the flow path and to communicate the second communication path with the flow path, the first path has a first opening connectable to the first communication path and a second opening connectable to the flow path, the second path has a third opening connectable to the first communication path, a fourth opening connected to the second communication path, and a fifth opening connectable to the flow path, an axial direction of the first path is aligned with the axial direction of the flow path, and a total opening area of the third opening and the fourth opening is larger than an opening area of the fifth opening.

According to such embodiment, by rotating the rotating section about the rotation axis, it is possible to easily switch between the ejection of the molten material and the ejection of the fiber material from the nozzle.

(3) In the above-described aspect, may be such that, the control section is configured to cause, in the first mode, the rotating section to rotate about the rotation axis to a position where at least a portion of a first communication path opening, which is an end section of the first communication path connected to the rotating section, overlaps at least a portion of the first opening, where at least a portion of a flow path opening, which is an end section of the flow path connected to the rotating section, overlaps at least a portion of the second opening, and where the flow path opening and the fifth opening do not overlap.

According to this configuration, only the molten material can be ejected from the nozzle in the first mode.

(4) In the above-described aspect, the control section may be configured to cause, in the second mode, the rotating section to rotate about the rotation axis to the position where at least a portion of a first communication path opening, which is an end section of the first communication path connected to the rotating section, overlaps at least a portion of the third opening and where at least a portion of a flow path opening, which is an end section of the flow path connected to the rotating section, overlaps at least a portion of the fifth opening.

According to this configuration, both the molten material and the fiber material can be ejected from the nozzle in the second mode.

(5) In the above-described aspect the control section may be configured to cause, in the third mode, the rotating section to rotate about the rotation axis to a position where a flow path opening, which is an end section of the flow path connected to the rotating section, does not overlap with either the second opening or the fifth opening.

According to this configuration, neither the molten material nor the fiber material can be ejected from the nozzle in the third mode.

(6) In the above-described aspect may be such that, it includes a plurality of the second communication paths, wherein the fiber material supply section supplies different types of fiber materials to the respective second communication paths, the rotating section includes a plurality of second paths, and the fourth opening of each of the second paths is connected to a different one of the second communication paths.

According to such the embodiment, different types of fiber materials can be ejected from the nozzle.

(7) In the above-described aspect, a first fiber material communication path and a second fiber material communication path that are second communication paths, wherein the fiber material supply section executes supplying a first fiber material to the first fiber material communication path and supplying a second fiber material, which is a different type of fiber material than the first fiber material, to the second fiber material communication path, the rotating section includes a first fiber material communication path and a second fiber material communication path which are the second paths, the fourth opening of the first fiber material communication path is connected with the first fiber material communication path, the fourth opening of the second fiber material communication path is connected with the second fiber material communication path, and when the fiber material ejected from the nozzle is switched from the first fiber material to the second fiber material, the control section causes the rotating section to rotate about the rotation axis so as to change from a first state in which at least a portion of the fifth opening of the first fiber material communication path and at least a portion of an flow path opening, which is an end section of the flow path connected to the rotating section, overlap each other to a second state in which at least a portion of the fifth opening of second fiber material communication path and at least a portion of the flow path opening overlap each other.

According to such an embodiment, the type of the fiber material ejected from the nozzle can be easily switched.

(8) In the above-described aspect, the first path may be provided between the two second paths in a rotation direction of the rotating section.

According to such the embodiment, it is possible to quickly switch from the second mode to the first mode.

(9) In the above-described aspect, the fourth opening and the third opening may be provided side by side in a direction orthogonal to and radially separated from the rotation axis.

According to such the embodiment, when the rotating section includes a plurality of second paths, the third opening and the fourth opening communicating with each other can be easily recognized.

(10) In the above-described aspect, when viewed from a direction along the rotation axis, a distance between the rotation axis and the plasticizing section may be greater than a distance between the rotation axis and the fiber material supply section.

(11) In the above-described aspect, a piece of heat insulation material that may be arranged between the second communication path and the plasticizing section.

According to this configuration, it is possible to reduce the influence of the heat of the plasticizing section on the fiber material passing through the second communication path.

(12) In the above-described aspect, it may further include a nozzle heater arranged around a portion of the flow path that is located near the nozzle.

According to this configuration, since the molten material can be heated immediately before being ejected from the nozzle, the molten material can be more stably ejected from the nozzle.

What is claimed is:

1. A three-dimensional molding device comprising:
a plasticizing section configured to plasticize at least a portion of a material containing thermoplastic resin to generate molten material;
a fiber material supply section configured to supply fiber material;
a first communication path communicating with the plasticizing section and configured to allow the molten material to pass through;
at least one second communication path communicating with the fiber material supply section and through which the fiber material passes;
a flow path configured to allow passage of the molten material that passed through the first communication path and the fiber material that passed through the second communication path;
a material switching section connected to the first communication path, to the second communication path, and to the flow path, and configured to switch communication state of the first communication path, the second communication path, and the flow path;
a nozzle that communicates with the flow path and that ejects the molten material and the fiber material that passed through the flow path onto a stage; and
a control section configured to control the plasticizing section, the fiber material supply section, and the material switching section to form a three-dimensional molded object including the molten material on the stage, wherein
the material switching section includes a rotating section that rotates about a rotation axis that is along an axial direction of the flow path and
the control section controls the material switching section to switch among
a first mode in which the first communication path is in communication with the flow path and the second communication path is not in communication with the flow path,
a second mode in which both the first communication path and the second communication path are in communication with the flow path, and
a third mode in which neither the first communication path nor the second communication path communicates with the flow path.

2. The three-dimensional molding device according to claim 1, wherein
the rotating section includes
a first path that is a through hole configured to communicate the first communication path with the flow path and
at least one second path that is a through hole configured to communicate the first communication path with the flow path and to communicate the second communication path with the flow path,
the first path includes
a first opening connectable to the first communication path and
a second opening connectable to the flow path,
the second path includes
a third opening connectable to the first communication path,
a fourth opening connected to the second communication path, and
a fifth opening connectable to the flow path,
an axial direction of the first path is aligned with the axial direction of the flow path, and
a total opening area of the third opening and the fourth opening is larger than an opening area of the fifth opening.

3. The three-dimensional molding device according to claim 2, wherein
the control section is configured to cause, in the first mode, the rotating section to rotate about the rotation axis to a position
where at least a portion of a first communication path opening, which is an end section of the first communication path connected to the rotating section, overlaps at least a portion of the first opening,
where at least a portion of a flow path opening, which is an end section of the flow path connected to the rotating section, overlaps at least a portion of the second opening, and
where the flow path opening and the fifth opening do not overlap.

4. The three-dimensional molding device according to claim 2, wherein
the control section is configured to cause, in the second mode, the rotating section to rotate about the rotation axis to the position
where at least a portion of a first communication path opening, which is an end section of the first communication path connected to the rotating section, overlaps at least a portion of the third opening and
where at least a portion of a flow path opening, which is an end section of the flow path connected to the rotating section, overlaps at least a portion of the fifth opening.

5. The three-dimensional molding device according to claim 2, wherein
the control section is configured to cause, in the third mode, the rotating section to rotate about the rotation axis to a position
where a flow path opening, which is an end section of the flow path connected to the rotating section, does not overlap with either the second opening or the fifth opening.

6. The three-dimensional molding device according to claim 2, further comprising:
a plurality of second communication paths, wherein
the fiber material supply section supplies different types of fiber materials to the respective second communication paths,
the rotating section includes a plurality of second paths, and
the fourth opening of each of the second paths is connected to a different one of the second communication paths.

7. The three-dimensional molding device according to claim 6, further comprising:
a first fiber material communication path and a second fiber material communication path that are second communication paths, wherein
the fiber material supply section executes
supplying a first fiber material to the first fiber material communication path and
supplying a second fiber material, which is a different type of fiber material than the first fiber material, to the second fiber material communication path,
the rotating section includes a first fiber material communication path and a second fiber material communication path which are the second paths,
the fourth opening of the first fiber material communication path is connected with the first fiber material communication path,
the fourth opening of the second fiber material communication path is connected with the second fiber material communication path, and
when the fiber material ejected from the nozzle is switched
from the first fiber material to the second fiber material, the control section causes the rotating section to rotate about the rotation axis so as to change from a first state in which at least a portion of the fifth opening of the first fiber material communication path and at least a portion of an flow path opening, which is an end section of the flow path connected to the rotating section, overlap each other
to a second state in which at least a portion of the fifth opening of second fiber material communication path and at least a portion of the flow path opening overlap each other.

8. The three-dimensional molding device according to claim 6, wherein
the first path is provided between the two second paths in a rotation direction of the rotating section.

9. The three-dimensional molding device according to claim 2, wherein
the fourth opening and the third opening are provided side by side in a direction orthogonal to and radially separated from the rotation axis.

10. The three-dimensional molding device according to claim 1, wherein
when viewed from a direction along the rotation axis, a distance between the rotation axis and the plasticizing section is greater than a distance between the rotation axis and the fiber material supply section.

11. The three-dimensional molding device according to claim 1, further comprising:
a piece of heat insulation material that is arranged between the second communication path and the plasticizing section.

12. The three-dimensional molding device according to claim 1, further comprising:
a nozzle heater arranged around a portion of the flow path that is located near the nozzle.
